(19) United States
(12) Patent Application Publication
(10) Pub. No.: US 2025/0172717 A1
(43) Pub. Date: May 29, 2025

(54) METHODS AND SYSTEMS FOR LOCATING AN UNDERGROUND OPTICAL FIBER

(71) Applicant: EXFO INC., Quebec (CA)

(72) Inventors: Michel LECLERC, Quebec (CA); Hongxin CHEN, Quebec (CA)

(21) Appl. No.: 18/956,502

(22) Filed: Nov. 22, 2024

Related U.S. Application Data
(60) Provisional application No. 63/602,860, filed on Nov. 27, 2023.

(51) Int. Cl. G01V 8/16; G01B 11/22; G01H 9/00

(52) U.S. Cl. CPC G01V 8/16; G01B 11/22; G01H 9/004

(57) ABSTRACT

A method and a system for locating an underground optical fiber extending under a target ground surface are disclosed. The method includes performing a plurality of measurements at a plurality of waypoints of an inspection path over the target ground surface. Each measurement includes generating a vibration event at the corresponding waypoint, concurrently to the generation of the vibration event, sending a test signal sensitive to the vibration event in the underground optical fiber, receiving a return test signal therefrom and determining an amplitude of the return test signal. The method includes determining a relative surface position of a segment of the underground optical fiber crossed by the inspection path. The method includes determining a depth of the underground optical fiber by obtaining a vibration fitting curve by fitting the amplitudes of the return signals for each of the waypoints and calculating the depth of the underground optical fiber.

### CROSS-REFERENCE TO RELATED APPLICATIONS

The present application claims priority to U.S. Provisional Patent Application No. 63/602,860 titled “FINDING THE DEPTH OF AN OPTICAL FIBER CABLE USING DISTRIBUTED VIBRATION SENSING”, filed Nov. 27, 2023.

### TECHNICAL FIELD

The technical field generally relates to optical fiber location, and more particularly to the determination of a location of an underground optical fiber.

### BACKGROUND

In order to meet the rising demand for international communications, extensive installations of optical communications infrastructure, such as optical fibers, have been deployed. Furthermore, it is known that these communications facilities can be buried and deployed underground (e.g. in conduits) to protect them from environmental factors and physical damage.

Determining positions of optical fiber can be a challenging task in a variety of contexts. Despite existing maps that aim to document their locations, fiber-based communication networks typically include a large number of underground optical fibers which may be deployed over numerous routes in such a way that precisely tracking those routes can be a cumbersome and error-prone operation. Records may over time become outdated due to construction projects, land changes, or even simple human error (e.g. during installation). In many cases, the maps may thus include location indications that are inaccurate. For example, an underground optical fiber might be a few meters away from its indicated location. This imprecision creates difficulties for construction teams or any operators, who must avoid damaging the underground optical fibers while digging or excavating. Without precise knowledge of where the cables are located, accidental damage can disrupt service for entire neighborhoods or businesses, leading to costly repairs and inconveniences.

Therefore, systems and methods for locating an underground optical fiber extending under a target ground surface that can alleviate at least some of these drawbacks may be desirable.

### SUMMARY

In accordance with one aspect, there is provided a method for locating an underground optical fiber extending under a target ground surface. The method includes performing a plurality of measurements at a plurality of waypoints of an inspection path over the target ground surface. Each measurement includes determining a set of waypoint coordinates of the corresponding waypoint, generating a vibration event at the corresponding waypoint, concurrently to the generation of the vibration event, sending a test signal sensitive to the vibration event in the underground optical fiber, and receiving a return test signal therefrom; and determining an amplitude of the return test signal. The method further includes determining a relative surface position corresponding to a position on the target ground surface extending directly above a segment of the underground optical fiber crossed by the inspection path, said relative surface position being associated with a maximum in the amplitudes of the return test signals. The method further includes determining a depth of the underground optical fiber by obtaining a vibration fitting curve by fitting the amplitudes of the return signals for each of the waypoints with respect to a distance scale based on the sets of waypoint coordinates of the corresponding waypoints and calculating the depth of the underground optical fiber from said vibration fitting curve.

In some implementations, the steps of sending the test signal and receiving the return test signal are performed by employing a Distributed Vibration Sensing (DVS) interrogating unit optically connected to the underground optical fiber and using Optical Time domain Reflectometry (OTDR).

In some implementations, calculating the depth of the underground optical fiber includes calculating a distance along the distance scale between a maximum point and a half-maximum point of the vibration fitting curve.

In some implementations, the depth of the underground optical fiber corresponds to half a width at half-maximum of the vibration fitting curve.

In some implementations, determining a set of waypoint coordinates of each waypoint includes determining a set of Global Positioning System (GPS) coordinates for the waypoint.

In some implementations, the relative surface position is determined based on a set of waypoint coordinates of one of said waypoints for which the amplitude of the corresponding return test signal is maximal.

In some implementations, the relative surface position is determined based on a maximum of the vibration fitting curve.

In some implementations, the inspection path is substantially straight and a distance between two consecutive waypoints along the inspection path is constant.

In some implementations, generating a vibration event includes employing a vibration generator unit configured to navigate along the inspection path and generate the vibration events at the waypoints of the inspection path.

In some implementations, the vibration generator unit is configured to navigate at a constant speed along the inspection path, and wherein a time delay between the generations of two consecutive vibration events is constant during the navigation of the vibration generator unit along the inspection path.

In some implementations, the vibration generator unit is operated by a human operator.

In some implementations, the method further includes, subsequent to determining a set of waypoint coordinates of the corresponding waypoint, establishing a first communication link between an operator device associated with the human operator and the vibration generator unit, establishing a second communication link between the operator device and an interrogating unit configured to send the plurality of test signals and receive the plurality of return test signals, receiving, upon the vibration events being generated by the vibration generator unit at a given waypoint, indications of current amplitudes of the return test signal by the operator device from the interrogating unit and concurrently displaying the indications of the current amplitude and a current position of the vibration generator unit on a display screen of the operator device.

In some implementations, the operator device is a portable device selected from a group of devices including: a cellphone, a laptop and a tablet.

In some implementations, the method further includes, prior to performing the plurality of measurements, locating the target ground surface within a ground surface area by generating at least one initial vibration event on an exploration point of the ground surface area, concurrently to the generation of the at least one initial vibration event, sending a plurality of test signals sensitive to the initial vibration events in the underground optical fiber, and receiving one or more return test signal therefrom, and in response to an amplitude of one of the return test signals being above a pre-determined threshold, identifying the target ground surface as a portion of the ground surface area around the exploration point.

In some implementations, the underground optical fiber is a single mode fiber.

In some implementations, the method further includes determining and storing geolocation data about the relative surface position in a database.

In some implementations, the method further includes determining a distance, along the underground optical fiber, between the interrogating unit and the relative surface position based on the geolocation data.

In accordance with another aspect, there is provided a system for locating of an underground optical fiber extending under a target ground surface. The system includes an interrogating unit optically connected to the underground optical fiber and configured to send test signals sensitive to the vibration event in the underground optical fiber and receive return test signals therefrom, the target ground surface being subjected to vibration events generated at waypoints of an inspection path and a controller communicably connected to the interrogating unit. The controller is configured to determine an amplitude of each of said return test signals, determine a relative surface position corresponding to a position on the target ground surface extending directly above a segment of the underground optical fiber crossed by the inspection path, said relative surface position being associated with a maximum in the amplitudes of the return test signals and determine a depth of the underground optical fiber. To do so, the controller is configured to obtain a vibration fitting curve by fitting the amplitudes of the return signals for each of the waypoints with respect to a distance scale based on sets of waypoint coordinates of the corresponding waypoints and calculate the depth of the underground optical fiber from said vibration fitting curve.

In some implementations, the interrogating unit is a Distributed Vibration Sensing (DVS) interrogating unit using Optical Time domain Reflectometry (OTDR).

In some implementations, the controller is configured to calculate the depth of the underground optical fiber by calculating a distance along the distance scale between a maximum point and a half-maximum point of the vibration fitting curve.

In some implementations, the depth of the underground optical fiber corresponds to half a width at half-maximum of the vibration fitting curve.

In some implementations, the controller is configured to determine the relative surface position based on a set of waypoint coordinates of a waypoint for which the amplitude of the corresponding return test signal is maximal.

In some implementations, the controller is configured to determine the relative surface position based on an abscissa of a maximum of the vibration fitting curve.

In some implementations, the underground optical fiber is a single mode fiber.

In accordance with yet another aspect, there is provided a method for locating an underground optical fiber extending under a target ground surface. The method includes determining respective relative surface positions of a plurality of segments of the underground optical fiber, the relative surface position of a given segment of the underground optical fiber corresponding to a position on the target ground surface extending directly above the given segment. Said determination being performed by, for each segment, performing a plurality of measurements at a plurality of waypoints of an inspection path over the target ground surface. Each measurement includes determining a set of waypoint coordinates of the corresponding waypoint, generating a vibration event at the corresponding waypoint, concurrently to the generation of the vibration event, sending a test signal sensitive to the vibration event in the underground optical fiber, and receiving a return test signal therefrom and determining an amplitude of the return test signal. The determination of the relative surface position of each segment further includes identifying the relative surface position of the segment as a maximum of the amplitudes of the return test signals. The method further includes determining a surface position of a portion of the underground optical fiber extending between at least two consecutive segments of the underground optical fiber thereof based on the relative surface positions thereof.

In some implementations, the method further includes determining respective depths of the at least two consecutive segments by, for each segment obtaining a vibration fitting curve by fitting the amplitudes of the return signals for each of the waypoints with respect to a distance scale based on the sets of waypoint coordinates of the corresponding waypoints, and calculating the depth of the segment from said segment vibration fitting curve. The method also includes determining a position of the portion of the underground optical fiber extending between the at least two consecutive segments based on the relative surface positions and the depths thereof.

Other features and advantages will be better understood upon of reading of detailed implementations with reference to the appended drawings.

### BRIEF DESCRIPTION OF THE DRAWINGS

The features and advantages of the present disclosure will become apparent from the following detailed description, taken in combination with the appended drawings, in which:

FIG. 1 is a schematic representation of a system for locating an underground optical fiber extending under a target ground surface in accordance with non-limiting implementations of the present technology;

FIG. 2 is a block diagram of a controller of the system of FIG. 1 in accordance with non-limiting implementations of the present technology;

FIG. 3A is a schematic representation of a vibration generating unit and an operator device in accordance with non-limiting implementations of the present technology;

FIG. 3B is a graph showing amplitudes of return test signals received by the system from an underground optical fiber in accordance with non-limiting implementations of the present technology;

FIG. 4 shows a correspondence between the graph of FIG. 3A and a location of a segment of the underground optical fiber;

FIG. 5 is an experimental graph of amplitudes of return test signals received by the system from an underground optical fiber;

FIG. 6 is a flow diagram showing operations of a method for locating an underground optical fiber extending under a target ground surface in accordance with some non-limiting implementations of the present technology; and

FIG. 7 is a schematic representation of a portion of an underground optical fiber extending between a first segment and a second segment.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims. It should also be noted that, unless otherwise explicitly specified herein, the drawings are not to scale.

### DETAILED DESCRIPTION

Various representative implementations of the described technology will be described more fully hereinafter with reference to the accompanying drawings, in which representative implementations are shown. The present technology concept may, however, be implemented in many different forms and should not be construed as limited to the representative implementations set forth herein. Rather, these representative implementations are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

It will be understood that, although the terms first, second, third, etc. may be used herein to describe various elements, these elements should not be limited by these terms. These terms are used to distinguish one element from another, without necessarily imparting a preferred order or sequence to these elements. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagram herein represents conceptual views of illustrative circuitry embodying the principles of the present technology.

Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “controller”, “processor” or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present disclosure.

In one aspect, the present technology provides a method for locating an underground optical fiber extending under a target ground surface.

In the context of the present disclosure, an underground optical fiber may be understood as an optical fiber deployed below a ground surface of an infrastructure that may be indoors or outdoors, and that may be used to carry optical signals as part of a communication network. The infrastructure may for example be a road section, a pavement, a field or any ground surface, a building, a private house or any structure suitable for integrating an optical fiber. The communication network may be embodied by a portion of an optical fiber telecommunication network such as a long-distance network, a Passive Optical Network (PON) or a Local Area Network (LAN).

In the context of the present disclosure, a target ground surface may be understood as a specific area or section of ground identified (e.g. on a map) as a designated zone for a search for the underground optical fiber. In some implementations, this defined area provides boundaries for human operators, guiding them on where to focus their search efforts and preventing unnecessary or unproductive exploration outside of the intended region. The target ground surface can vary in size and shape, and may be chosen based on certain criteria such as location, accessibility, or relevant physical characteristics of the environment of the target ground surface. For example, the target ground surface may be defined as a square surface (e.g. with five-meter side) centered on an expected position of a segment of the underground optical fiber. The expected position may be extracted from a map indicative of expected positions of underground optical fibers of the communication network.

In accordance with one aspect, the present technology enables the location of the underground optical fiber through the determination of (i) a relative surface position and (ii) a depth of the underground optical fiber extending under the target ground surface.

In the context of the present disclosure, the relative surface position may be understood as a position on the target ground surface extending directly above a segment of the underground optical fiber crossed by the inspection path. It may further be understood as a position of a substantially orthogonal projection of a segment of the underground optical fiber on the ground surface. The relative surface position thus indicates where, on the visible ground level, an operator or tool should focus when aiming to access or excavate said segment of the underground optical fiber. In some embodiments, the relative surface position may be expressed as a set of two-dimensional (2D) coordinates of the segment of the underground optical fiber on the target ground surface. Illustrative examples of relative surface positions are detailed herein after. The depth of the underground optical fiber thus refers to a vertical distance between the segment of the underground optical fiber and the ground level.

In typical communication networks, the underground optical fibers are potentially affected by vibration events therealong. For example, different sources of vibrations such as road traffic, cars, trucks, and trains may affect an underground optical fiber located nearby. A vibration event may be understood as any instance where such vibrations from external sources reach an underground optical fiber and impart a corresponding vibration movement on this optical fiber. Implementations of the present method disclosed herein advantageously make use of test signals sensitive to vibration events artificially generated along an inspection path on a target ground surface to determine a location of an underground optical fiber, as explained further below.

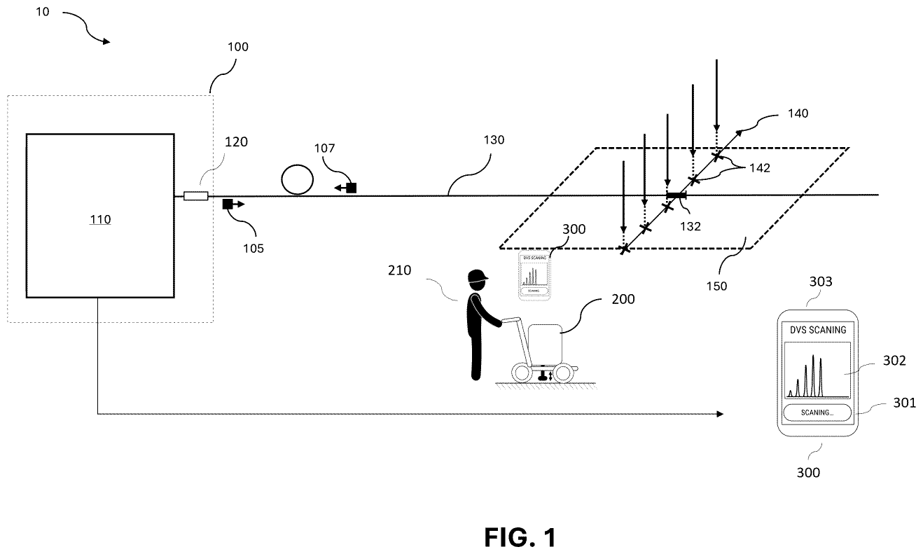

Referring to FIG. 1, there is shown an example of a system 100 suitable for executing of the aforementioned method in accordance with some non-limiting implementations of the present technology. Generally speaking, the system 100 is configured for locating an underground optical fiber extending under a target ground surface. As such, any system variation configured to enable location of an underground optical fiber can be adapted to execute implementations of the present technology, once teachings presented herein are appreciated.

The system 100 includes a controller 110 and an interrogating unit 120 communicably connected thereto. In use, the interrogating unit 120 is optically connected to an underground optical fiber 130. Broadly speaking, the system 100 may be used to locate a segment 132 of the underground optical fiber 130 below a target ground surface 150. Identification and location of the target ground surface are described in greater detail herein after. Components of the system 100 may be implemented in a landing site such as an electric cabinet including server racks or any other suitable landing point for optical fibers. Of course, this configuration is shown for illustrative purposes only and is not meant to limit the scope of protection to similar configurations.

In use, the interrogating unit 120 sends a test signal 105 sensitive to vibration events in the underground optical fiber 130 and receives a return test signal 107 therefrom. As will be described in greater detail herein after, the methods disclosed herein takes advantage of vibration events artificially generated on the target ground surface 150 to locate the segment 132 of the underground optical fiber 130. In some implementations, the underground optical fiber 130 may be a single mode fiber.

In some implementations, the interrogating unit 120 may rely on Optical Time-Domain Reflectometry (OTDR—also used to refer to the corresponding device). OTDR devices send laser pulses, embodying the test signal, through an optical fiber and analyse the reflected light returning to the device, embodying the return test signal, to detect signal losses and measure the distance of loss events from the optical fiber input. As is known in the art, during propagation of the test signal 105, a portion thereof may be scattered back towards the source due to Rayleigh scattering, which arises from microscopic variations of the material density and composition of the underground optical fiber 130. Additionally, significant reflections may occur at discrete points where there is an abrupt change in the refractive index, such as at fiber splices, connectors, or faults.

In this implementation, the interrogating unit 120 includes an OTDR device sending the test signal 105 through the underground optical fiber 130 and receiving the return test signal 107 therefrom. In the context of the present disclosure, an OTDR device may be, without being limited to, a Distributed Acoustic Sensing (DAS)-OTDR device, or a Distributed Vibration Sensing (DVS)-OTDR device, or another variant of an OTDR device capable of performing vibration measurement along optical fibers (e.g. by employing a laser source that is substantially coherent). For example, Rayleigh scatter-based DAS uses a Coherent OTDR (C-OTDR) where a coherent laser pulse is sent along the optical fiber. As similar measurement technique in conventional OTDRs, for the C-OTDR the interfered intensities of any two or more reflected coherent lights are measured as a function of time after transmission of the laser pulse. It will however be understood that implementations of the present technology are not limited to OTDR implementations. In other implementations, the test signals sensitive to the vibration events may for example be embodied by an Optical Frequency Domain Reflectometry (OFDR) device, that operates by modulating the frequency of a laser source over time, creating a varying optical signal that is injected into the underground optical fiber 130. As the modulated signal travels through the underground optical fiber, some of the light may be backscattered or reflected due to vibration events affecting the underground optical fiber.

Summarily, vibration events affecting the underground optical fiber may be a cause of light scattering or reflection and can therefore be detected and characterized through a proper analysis of said scattered or reflected light. In some implementations, vibration events may apply a local strain on an underground optical fiber, which may locally cause a deformation of the underground optical fiber (e.g. a local elongation). By generating vibration events with constant vibration intensity on the target ground surface 150 and measuring the amplitude of the return test signals, the interrogating unit 120 may determine the relative surface position and depth of the underground optical fiber 130, as will be described in greater detail herein after.

Referring still to FIG. 1, the controller 110 of the system 100 may be configured to determine the location of the segment 132 of the underground optical fiber 130. In the depicted non-limiting implementation of FIG. 1, the controller 110 is a single controller. In alternative non-limiting implementations of the present technology, the functionality of the controller 110 may be distributed and may be implemented via multiple devices. For example, the functionality of the controller 110 relative to the aforementioned OTDR device and/or the interrogating unit 120 may be implemented in the corresponding OTDR device/or the interrogating unit 120 respectively.

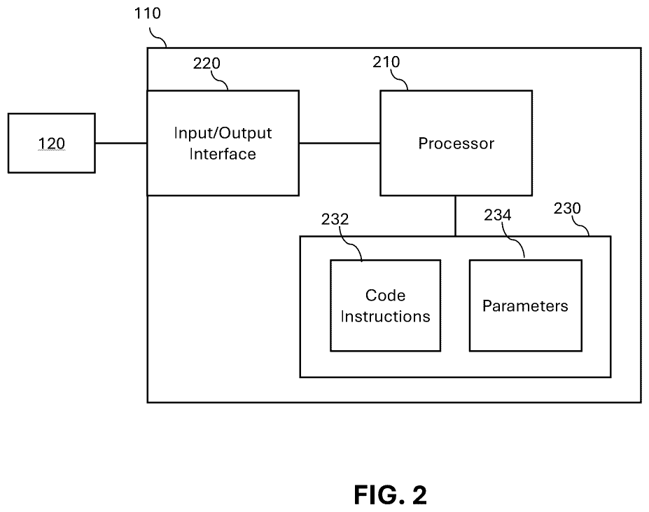

As an example, FIG. 2 is a schematic block diagram of the controller 110 of the system 100 according to some implementations of the present technology. The controller 110 includes a processor or a plurality of cooperating processors (represented as a processor 210 for simplicity), a memory device or a plurality of memory devices (represented as a memory device 230 for simplicity), and an input/output interface 220 allowing the controller 110 to communicate with other components of the system 100 and/or other components in remote communication with the system 100. The processor 210 is operatively connected to the memory device 230 and to the input/output interface 220. The memory device 230 includes a storage for storing parameters 234. The memory device 230 may include a non-transitory computer-readable medium for storing code instructions 232 that are executable by the processor 210 to allow the controller 110 to perform the various tasks allocated to the controller 110 in the methods disclosed herein.

In this implementation, the controller 110 is operatively connected, via the input/output interface 220, to the interrogating unit 120. The controller 110 executes the code instructions 232 stored in the memory device 230 to implement the various above-described functions that may be present in a particular implementation. FIG. 2 as illustrated represents a non-limiting implementation in which the controller 110 orchestrates operations of the interrogating unit 120. This particular implementation is not meant to limit the present disclosure and is provided for illustration purposes.

Operations of the system 100 in collaboration with a vibration generating unit 200 to locate the segment 132 of the underground optical fiber 130 will now be described. Broadly speaking, vibration events are artificially generated on the target ground surface 150 and resulting varying amplitudes of a plurality of return test signals are analysed to determine a relative surface position of the underground optical fiber 130 and a depth thereof.

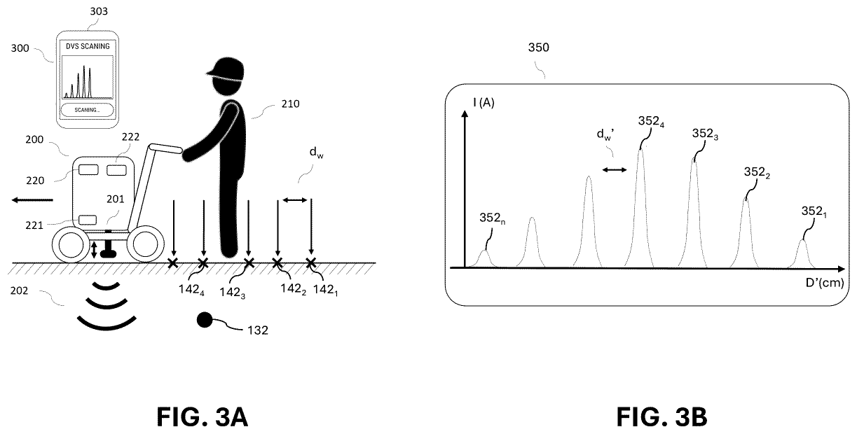

With reference to FIGS. 1 and 3A, a plurality of measurements are initially performed at a plurality of waypoints 142 of an inspection path 140 over the target ground surface 150. In the context of the present disclosure, an inspection path is a pre-defined designated route where vibration events are generated to assess the location of the segment 132. In the illustrative implementation of FIGS. 1 and 3A, the inspection path 140 is a straight line. The inspection path 140 may have a different shape (e.g. S-shaped) in alternative implementations, for example in instances where obstacles are present on the ground surface. The inspection path 140 includes waypoints 142 there along that may be predefined intermediate points of the inspection path 140 where vibration events will be generated. In use, the waypoints 142 may help to ensure that measurements are thorough and consistent.

Each measurement includes determining a set of waypoint coordinates of a corresponding waypoint and generating a vibration event at the corresponding waypoint. In this implementation, the vibration event is generated by a vibration generating unit 200 configured to navigated along the inspection path 140. As best shown on FIG. 3A, in some implementations the vibration generating unit 200 is mobile (e.g. includes wheels or tracks) and may include a hammer head 201 configured to generate repeatable vibration event 202 (i.e. with a same pattern and intensity) on the target ground surface 150 at waypoints 142 of the inspection path 140, a controller 222 and a Global Positioning System (GPS) module 220. In some implementations, the vibration generating unit 200 is operated by a human operator 210.

The GPS module 220 is configured to generate data indicative of a current position of the vibration generating unit 200. Prior to actuating the hammer head 201, the controller 222 of the vibration generating unit 200 may thus store data generated by the GPS module 220 to determine the set of waypoint coordinates (e.g. a set of GPS coordinates) of the corresponding waypoint. Once the set of waypoint coordinates is determined, the controller 222 actuates the hammer head 201 to strike the target ground surface 150 and generates a pulse of energy that travels as vibration 202 through the ground. When the hammer head 201 impacts the target ground surface 150, a shock wave radiates from the current waypoint, causing vibrations in the surrounding area and potentially in the underground optical fiber 130.

Each measurement includes, concurrently to the generation of the vibration event, sending, by the interrogating unit 120, a test signal 105 sensitive to the vibration event in the underground optical fiber 130, and receiving a return test signal 107 therefrom. In this implementation, the steps of sending the test signal 150 and receiving the return test signal 107 are performed by the interrogating unit 120 using Optical Time domain Reflectometry (OTDR). The interrogating unit 120 further determines an amplitude of the return test signal 107. Analysis of the amplitudes of the return test signals is described in greater detail with respect to FIGS. 3B to 5.

Once the measurement has been performed at the current waypoint, the vibration generating unit 200 navigates to a subsequent waypoint of the inspection path 140 and the measurement operation is repeated at the subsequent waypoint. In this implementation, the vibration generation unit 200 may further include an odometer 221 (e.g. a wheel revolution counter) to determine the distance between consecutive waypoints 142 along the inspection path 140. In the same or alternative implementations, the vibration generator unit 200 is configured to navigate at a constant speed along the inspection path 140, and a time delay between the generations of two consecutive vibration events is constant during the navigation of the vibration generator unit 200 along the inspection path 140.

In some implementations, a distance d_{w} between two consecutive waypoints 142 may be constant along the inspection path 140. For example, the human operator 210 may stop the vibration generating unit 200 in response to data generated by the odometer 221 being indicative that the distance from the previous waypoint reaches the distance d_{w}. In other variants, the distance d_{w} between consecutive waypoints may vary along the inspection path.

FIG. 3B is graph 350 showing an example of amplitudes of return test signals received by the interrogating unit 120 from the underground optical fiber 130, each return test signal having been affected by vibration events generated at a corresponding waypoint 142.

In this example, each return test signal 352₁, 352₂, ( . . . ) 352ₙ corresponds to the return test signal received by the interrogating unit 120 when the vibration generating unit 200 generated a vibration event at the corresponding waypoint 142₁, 142₂, ( . . . ) 142ₙ, (see FIG. 3A). As the vibration generating unit 200 is configured to generate the vibration events in a repeatable manner (i.e. with a same pattern and intensity) and as the segment 132 is substantially located below the waypoint 142₄ in the illustrative implementation of FIG. 3A, the respective amplitudes of the return test signals 352₁ to 352₄ are in an ascending order. Indeed, the segment 132 undergoes a higher intensity of vibrations caused by the generation of the vibration event at the waypoint 142₄ compared to the vibration event at the waypoint 142₁, which affects the amplitude of the return test signal received by the interrogating unit 120.

On FIG. 3B, a distance d_{w}′ between consecutive return test signals 352₁ to 352₄ is proportional to the distance d_{w} between the corresponding waypoints 142₁ to 142₄. In other words, a distance scale of the amplitudes of the return test signals 352₁ to 352₄ is based on the sets of waypoint coordinates of the corresponding waypoints. The controller 110 may determine the distances between the return test signals based on data generated by the GPS module 220 and/or the odometer 221 of the vibration generating unit 200. In this implementation, the controller 222 of the vibration generating unit 200 is communicably connected to the controller 110 over a communication network via any wired or wireless communication link including, for example, 4G, LTE, Wi-Fi, or any other suitable connection, and transmits the set of waypoint coordinates and/or distances therebetween to the controller 110 over the communication network. In some implementations of the present technology, the communication network may be implemented as the Internet. In other implementations of the present technology, the communication network can be implemented differently, such as any wide-area communication network, local-area communication network, a private communication network and the like. How communication links between the controller 110 and the controller 222 are implemented will depend inter alia on how the controller 110 and the controller 222 are implemented.

In implementations where the vibration unit generator 200 is operated by the human operator 210, the controller 110 is also communicably connected to an operator device 300 associated with the human operator 210. In some implementations, the operator device 300 may be implemented by any of a conventional personal computer, a controller, and/or an electronic device (e.g., a server, a controller unit, a control device, a monitoring device etc.) and/or any combination thereof appropriate to the relevant task at hand. The operator device 300 may be, for example and without being limitative, a cellphone, a laptop, a tablet, a handheld computer, a personal digital assistant, a media player, a navigation device or a combination of two or more of these data processing devices or other data processing devices.

The operator device 300 may include various hardware components including one or more single or multi-core processors, a solid-state drive, a random access memory (RAM), a dedicated memory and an input/output interface. The input/output interface may provide networking capabilities such as wired or wireless access. As an example, the input/output interface may include a networking interface such as, but not limited to, one or more network ports, one or more network sockets, one or more network interface controllers and the like. Multiple examples of how the networking interface may be implemented will become apparent to the person skilled in the art of the present technology. As a person in the art of the present technology may appreciate, multiple variations as to how the operator device 300 is implemented may be envisioned without departing from the scope of the present technology.

Further, the operator device 300 may include a display 303 (see FIG. 1) or screen capable of rendering images, including maps. In some embodiments, the display 303 may be used to display maps that may include, for example, labels or marks indicative of a position of the waypoints 142, Graphical User Interfaces (GUIs), program output, etc. In some implementations, the display 303 includes and/or is housed with a touchscreen to permit the human operator 210 to input data via some combination of virtual keyboards, icons, menus, or other Graphical User Interfaces (GUIs). In some implementations, the display 303 may be implemented using a Liquid Crystal Display (LCD) display or a Light Emitting Diode (LED) display, such as an Organic LED (OLED) display. In other implementations, the display 303 may be remotely communicatively connected to the operator device 300 via a wired or a wireless connection (not shown), so that outputs of the operator device 300 may be displayed at a location different from the location of the operator device 300.

In this implementation, the operator device 300 is communicably connected to the controller 110 of the system 100 over a communication network via any wired or wireless communication link including, for example, 4G, LTE, Wi-Fi, or any other suitable connection, and receives indication of the amplitudes of the return test signals therefrom. In some implementations of the present technology, the communication network may be implemented as the Internet. In other implementations of the present technology, the communication network can be implemented differently, such as any wide-area communication network, local-area communication network, a private communication network and the like. How the communication links between the controller 110 and the operator device 300 are implemented will depend inter alia on how the controller 110 and the operator device 300 are implemented.

In some implementations, at least some of the functionalities of the controller 110 of the system 100 are controllable by a controller of the operator device 300. For example, the human operator 210 may cause the emission of the test signal 107 by the interrogating unit 120 upon clicking a scanning button 301 on the display 303. Once the return test signal has been received and analysed by the interrogating unit 120, the controller 110 may transmit information 302 (see FIG. 1) about the amplitudes of the return test signals to the operator device 300 for display to the human operator 210. In other words, the operator device 300 may receive, upon the vibration events being generated by the vibration generator unit 200 at a given waypoint 142, indications of current amplitudes of the return test signal from the controller 110.

In some implementations, the operator device 300 is also communicably connected to the controller 222 of the vibration generating unit 200 over a communication network via any wired or wireless communication link including, for example, 4G, LTE, Wi-Fi, or any other suitable connection. In this implementation, a communication link is established between the operator device 300 and the controller 222 over a Bluetooth Low Energy (BLE) connection. At least some of the functionalities of the controller 222 of the vibration generating unit 200 may also be controllable by the controller of the operator device 300. As such, the human operator 210 may control the actuation of the hammer head 201, receives data from the GPS module 220 and receive data from the odometer 221 via the operator device 300. In these implementations, the operator device 300 may concurrently display indications of the current amplitude of the return test signals received from the controller 110 and a current position of the vibration generator unit 200 received from the controller 222 on the display 303. For example, a gauge indicator may be displayed by the operator device 300 to the operator to show current and past amplitudes of the return test signals.

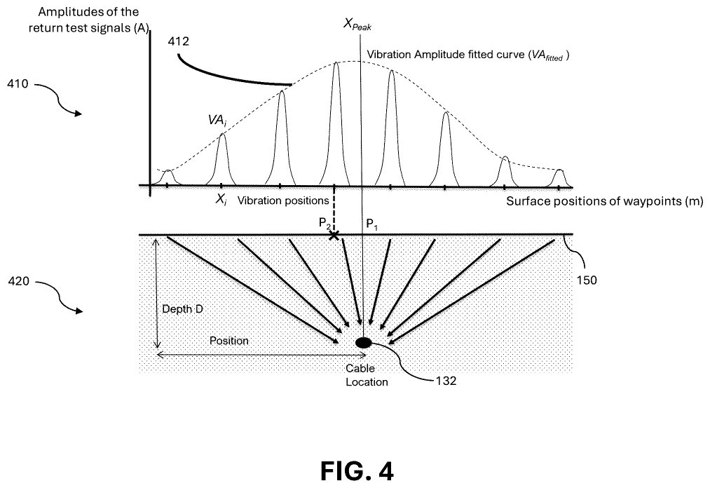

Referring to FIG. 4, the determination of the relative surface position of the segment 132 of the underground optical fiber 130 based on the plurality of measurements according to one implementation will now be described FIG. 4 includes a graph 410 showing an example of amplitudes VAᵢ of return test signals received by the interrogating unit 120 from the underground optical fiber 130, each return test signal having been affected by vibration events generated at a corresponding waypoint. Abscissas Xᵢ of the amplitudes VAᵢ on the horizontal axis are indicative of the surface position of the corresponding waypoint. In other words, the gap between the amplitudes VAᵢ on the graph 410 is proportional to a distance between the corresponding waypoints according to a distance scale as describe herein above. FIG. 4 also includes a schematic representation 420 of a cross section of the ground where the segment 132 is located. The representation 420 is positioned relatively to the graph 410 and aligned thereto to ease an understanding of the present technology. As can be seen on FIG. 4, the amplitude VA of the return test signals increases with a proximity of the corresponding waypoint to the segment 132. The closer the waypoint is to the segment, the higher is the amplitude of the corresponding return test signal.

In this implementation, a vibration fitting curve 412, also referred to as a vibration amplitude fitted curve VA_{fitted}, is applied to fit the amplitudes VA of the return test signals. The relative surface position of the segment 132 is determined based on a maximum of the vibration fitting curve 412. Said relative surface position is identified as P₁ on the target ground surface 150 FIG. 4. The abscissa of the maximum of the vibration fitting curve 412 is noted Xₚₑₐₖ. In some alternative implementations, the relative surface position of the segment 132 is determined based on a set of waypoint coordinates of one of said waypoints for which the amplitude VAᵢ of the corresponding return test signal is maximal. Said relative surface position is identified as P₂ on the target ground surface 150 FIG. 4.

In some implementations, geolocation data about the relative surface position may be determined by the system 100 and stored in a memory communicably connected thereto (e.g. a database). The geolocation data may include GPS coordinates of the relative surface position for example and may be used by the operator 210 to locate and/or map the underground optical fiber 130. The system 100 may further determine a distance, along the underground optical fiber 130, between the interrogating unit 120 and the relative surface position based on the geolocation data. Said distance may be relevant to the operator 210 or a manager of a network including the underground optical fiber 130. Indeed, knowing the distance between the relative surface position and the interrogating unit 120 may be relevant for diagnosing and maintaining performances of the underground optical fiber 130. This distance allows the operator to interpret test results accurately, identifying the exact location of potential faults such as signal loss or fiber breaks. Accurately measuring this distance may thus enhance fault localization, reduce maintenance time and costs, and help maintain consistent network performance.

Once the relative surface position of the segment 132 on the target ground surface 150 has been determined, the depth of the segment 132 may be calculated. In this implementation, the depth of the segment 132 of the underground optical fiber is calculated from said vibration fitting curve 412. The following set of equations can be derived from FIG. 4, which link the amplitudes of the return test signals and the distances between the waypoint coordinates and the segment 132.
VAᵢ=α/distance², where distance is the distance between the waypoint coordinates and the segment 132. Using simple geometry, this equation can be rewritten as:

$${VA}_{i} = α / ( {D}^{2} + {X}_{i , offse {t}^{2}} ) \qquad ( 1 )$$

where X_{i,offset}=Xᵢ−Xₚₑₐₖ, a is the medium damping coefficient of the ground and D is the depth of the segment 132.

For X_{i,offset}=0, equation (1) gives VAₘₐₓ=α/D² which is the maximum amplitudes of the vibration fitting curve 412. Additionally, for X_{i,offset}=D, equation (1) gives:

$${VA}_{i} ( {X}_{i , offset} = D ) = α / 2 {D}^{2} = 0.5 {VA}_{max} \qquad ( 2 )$$

It follows from these considerations that the depth of the segment 132 may be obtained by calculating a distance along the distance scale between a maximum point Xₚₑₐₖ and a half-maximum point of the vibration fitting curve 142, according to equation (2). In other words, a distance on the target ground surface 150 between a waypoint for which the amplitude of the corresponding return test signal is half of the maximum of the vibration fitting curve 142 and the relative surface position of the segment 132 is equal to the depth of the segment 132. In some implementations, the depth of the segment 32 is directly identified as half of the full width at half-maximum of the vibration fitting curve 142.

The position of the segment 132 may further be derived from the relative surface position thereof and the depth determined as described herein above. It should be noted that, in some implementations, the target ground surface 150 is located and identified within a ground surface area before the plurality of measurements are performed. The determination of the location of the target ground surface may be performed by generating at least one initial vibration event on an exploration point of the ground surface area. Said exploration may be arbitrarily chosen by the operator 210 or selected based on GPS coordinates of the vibration generating unit matching a target set of coordinates (e.g. indicated in a map). Concurrently to the generation of the at least one initial vibration event, a plurality of test signals sensitive to the initial vibration events are sent in the underground optical fiber 130, and one or more return test signal is received therefrom. In response to an amplitude of one of the return test signals being above a pre-determined threshold, the target ground surface is identified as a portion (e.g. a square of 5-meter side) of the ground surface area around the exploration point. In response to the amplitude of the return test signals being below the pre-determined threshold, the position of exploration point on the ground surface is adjusted and the process is repeated.

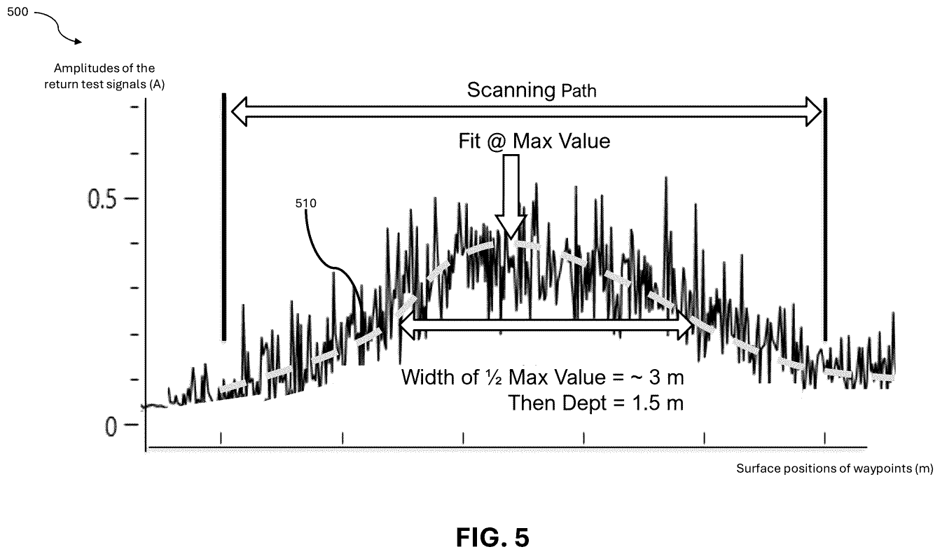

FIG. 5 is an experimental graph 500 of amplitudes of return test signals received by the system 100 from an underground optical fiber. In this illustrative example, a maximal amplitude of a vibration fitting curve 510 fitted to the amplitudes of the return test signals is about 0.5 A and gives an indication about the relative surface position of a segment of the underground optical fiber. The full width at half-maximum is about 3 meters, which indicates a depth of the segment of 3/2=1.5 meter.

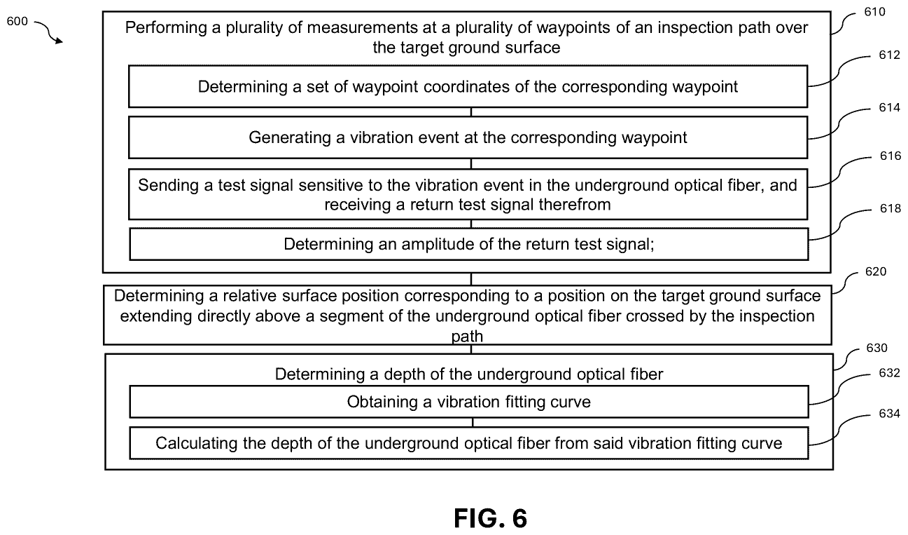

FIG. 6 is a flow diagram of a method 600 for locating an underground optical fiber extending under a target ground surface, such as the underground optical fiber 130 extending under the target ground surface 150, according to some implementations of the present technology. In one or more aspects, the method 600 or one or more steps thereof may be performed by a processor or a computer system, such as the system 100. The method 600 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 600 starts with performing, at operation 610, a plurality of measurements at a plurality of waypoints of an inspection path over the target ground surface, such as the target ground surface 150. For example, the inspection path may be substantially straight and a distance between two consecutive waypoints along the inspection path may be constant. In this implementation, each measurement includes determining, at sub-operation 612, a set of waypoint coordinates of the corresponding waypoint. For example, determining a set of waypoint coordinates of each waypoint may include determining a set of Global Positioning System (GPS) coordinates for the waypoint.

Each measurement also includes generating, at sub-operation 614, a vibration event at the corresponding waypoint. In this implementation, generating a vibration event includes employing a vibration generator unit, such as the vibration generator unit 200, configured to navigate along the inspection path and generate the vibration events at the waypoints of the inspection path. In some implementations, the vibration generator unit is operated by a human operator. The human operator may be associated with an operator device, such as a cellphone, a laptop or a tablet, to ease a location of the underground optical fiber by the operator. In these implementations, the method 600 further includes, subsequent to determining a set of waypoint coordinates of the corresponding waypoint, establishing a first communication link between an operator device associated with the human operator and the vibration generator unit, establishing a second communication link between the operator device and an interrogating unit configured to send the plurality of test signals and receive the plurality of return test signals, receiving, upon the vibration events being generated by the vibration generator unit at a given waypoint, indications of current amplitudes of the return test signal by the operator device from the interrogating unit and concurrently displaying the indications of the current amplitude and a current position of the vibration generator unit on a display screen of the operator device.

In this implementation, the vibration generator unit navigates at a constant speed along the inspection path, and a time delay between the generations of two consecutive vibration events is constant during the navigation of the vibration generator unit along the inspection path.

Each measurement further includes sending, at sub-operation 616 and concurrently to the generation of the vibration event, a test signal sensitive to the vibration event in the underground optical fiber, and receiving a return test signal therefrom, and determining, at sub-operation 618 an amplitude of the return test signal. In this implementation, the sub-operations of sending the test signal and receiving the return test signal are performed by employing a Distributed Vibration Sensing (DVS) interrogating unit optically connected to the underground optical fiber and using Optical Time domain Reflectometry (OTDR), such as the interrogating unit 120.

The method 600 continues with determining, at operation 620, a relative surface position corresponding to a position on the target ground surface extending directly above a segment of the underground optical fiber crossed by the inspection path, said relative surface position being associated with a maximum in the amplitudes of the return test signals. In some implementations, the relative surface position is determined based on a set of waypoint coordinates of one of said waypoints for which the amplitude of the corresponding return test signal is maximal. In some implementations, the method 600 also includes determining and storing geolocation data about the relative surface position in a database. For example, the database may be communicably connected to the system 100.

In some implementations, the method 600 also includes determining and storing geolocation data about the relative surface position in a database. The geolocation data may include GPS coordinates of the relative surface position for example and may be used in a later moment in time (e.g. by another operator) to locate and/or map the underground optical fiber. The method 600 may also include determining a distance, along the underground optical fiber, between the interrogating unit and the relative surface position based on the geolocation data. Said distance may be relevant to an operator of a network including the underground optical fiber. Indeed, knowing the distance between the relative surface position and the system 100 (or the at least the interrogating unit 120) may be used by the operator to accurately assess the integrity of the underground optical fiber and pinpoint potential faults. Since signal quality and strength can degrade over distance, measuring this distance helps the operator determine if issues like signal loss, attenuation, or breaks are occurring at specific points along the underground optical fiber. For example, by comparing the test results to the known distance, the operator can more effectively localize and address problems, ensuring efficient maintenance, minimizing service disruptions, and reducing costs associated with unnecessary excavation or repairs.

The method continues with determining, at operation 630, a depth of the underground optical fiber. In this implementation, the determination of the depth of the underground optical fiber includes obtaining, at sub-operation 632, a vibration fitting curve by fitting the amplitudes of the return signals for each of the waypoints with respect to a distance scale based on the sets of waypoint coordinates of the corresponding waypoints, and calculating, at sub-operation 634, the depth of the underground optical fiber from said vibration fitting curve. In this implementation, the relative surface position is determined based on a maximum of the vibration fitting curve.

In this implementation, calculating the depth of the underground optical fiber includes calculating a distance along the distance scale between a maximum point and a half-maximum point of the vibration fitting curve. For example, the depth of the underground optical fiber may correspond to half a width at half-maximum of the vibration fitting curve.

In some implementation, the method 600 includes, prior to performing the plurality of measurements, locating the target ground surface within a ground surface area. The determination of the location of the target ground surface may be performed by generating at least one initial vibration event on an exploration point of the ground surface area. Concurrently to the generation of the at least one initial vibration event, a plurality of test signals sensitive to the initial vibration events are sent in the underground optical fiber, and one or more return test signal is received therefrom. In response to an amplitude of one of the return test signals being above a pre-determined threshold, the target ground surface is identified as a portion of the ground surface area around the exploration point.

It will be appreciated that at least some of the operations of the method 600 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

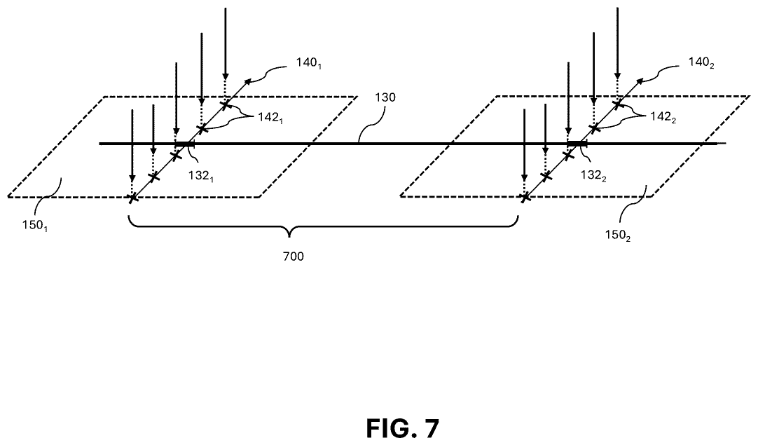

In some implementations, at least some of the operations of the method 600 may be repeated at least twice to determine the location of at lease two respective segments of the underground optical fiber 130. FIG. 7 is a schematic representation of the underground optical fiber 130 including a first segment 1321 and a second segment 1322.

In this implementation, some operations of the method 600 may be performed and repeated to determine respective relative surface position of a plurality of segments of the underground optical fiber 130 (e.g. by performing the operations 610 and 620 of the method 600 for each segment). For example, with respect to FIG. 7, a relative surface position of the first segment 1321 may be determined. More precisely, vibration events may be generated at waypoints 142₁ along a first inspection path 1401 on a first target ground surface 1501 to determine a relative surface position of the first segment 1321, as previously described with reference to FIG. 4 describing the determination of the relative surface position of the segment 132. These operations may be repeated on a second target ground surface 1502 to determine a relative surface position of the second segment 1322. More precisely, vibration events may be generated at waypoints 142₂ along a second inspection path 1402 on a second target ground surface 1501 to determine a relative surface position of the second segment 1322, as previously described with respect to the segment 132. It should be noted that the respective relative surface positions of more than two segments (e.g. ten) of the underground optical fiber may be determined in a similar manner.

A surface position of a portion 700 of the underground optical fiber 130 extending between the first and second segments 1321, 1322 thereof may further be determined based on the relative surface positions of the first and second segments 1321, 1322. It should be noted that, in the context of the present disclosure, the surface position of a portion of the underground optical fiber 130 may be understood as a projection of a direction of the portion onto the ground surface directly above it. In other words, the surface position of the portion 700 refers to a line portion projection, orthogonally projected on the ground surface that represents the orientation and direction of the portion of the underground optical fiber, as if “mapped” onto the ground surface above.

In some implementations, respective depths of the plurality of segments may also be determined (e.g. by performing the operation 630 of the method 600 for each segment). In this example, the respective depth of first and second segments 1321, 1322 are determined as previously described with respect to the depth of the segment 132. The locations of the first and second segments 1321, 1322 may thus be known based on respective relative surface positions and depths thereof. It should be noted that the respective depths of more than two segments (e.g. ten) of the underground optical fiber may be determined in a similar manner.

A direction of the portion 700 of the underground optical fiber 130 extending between the first and second segments 1321, 1322 may finally be determined based on the respective relative surface positions and depths of the first and second segments 1321, 1322. It should be noted that, in the context of the present disclosure, a position of the portion 700 of the underground optical fiber 10 may be understood as a spatial location and orientation in three dimensions of the line portion 700 that represents the path of the underground optical fiber between two specific points or segments thereof (here the first and second segments 1321, 1322). This position of a portion is thus indicative of the direction, orientation, and overall trajectory of the line portion 700 between these consecutive segments.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described implementations but should be defined only in accordance with the following claims and their equivalents.

1. A method for locating an underground optical fiber extending under a target ground surface, the method comprising:
performing a plurality of measurements at a plurality of waypoints of an inspection path over the target ground surface, each measurement comprising:
determining a set of waypoint coordinates of the corresponding waypoint;
generating a vibration event at the corresponding waypoint;
concurrently to the generation of the vibration event, sending a test signal sensitive to the vibration event in the underground optical fiber, and receiving a return test signal therefrom; and
determining an amplitude of the return test signal;
determining a relative surface position corresponding to a position on the target ground surface extending directly above a segment of the underground optical fiber crossed by the inspection path, said relative surface position being associated with a maximum in the amplitudes of the return test signals; and
determining a depth of the underground optical fiber, comprising:
obtaining a vibration fitting curve by fitting the amplitudes of the return signals for each of the waypoints with respect to a distance scale based on the sets of waypoint coordinates of the corresponding waypoints; and
calculating the depth of the underground optical fiber from said vibration fitting curve.

2. The method according to claim 1, wherein the steps of sending the test signal and receiving the return test signal are performed by employing a Distributed Vibration Sensing (DVS) interrogating unit optically connected to the underground optical fiber and using Optical Time domain Reflectometry (OTDR).

3. The method according to claim 1, wherein calculating the depth of the underground optical fiber comprises calculating a distance along the distance scale between a maximum point and a half-maximum point of the vibration fitting curve.

4. The method according to claim 3, wherein the depth of the underground optical fiber corresponds to half a width at half-maximum of the vibration fitting curve.

5. The method according to claim 1, wherein the relative surface position is determined based on a set of waypoint coordinates of one of said waypoints for which the amplitude of the corresponding return test signal is maximal.

6. The method according to claim 1, wherein the relative surface position is determined based on a maximum of the vibration fitting curve.

7. The method according to claim 1, wherein generating a vibration event comprises employing a vibration generator unit configured to navigate along the inspection path and generate the vibration events at the waypoints of the inspection path.

8. The method according to claim 7, wherein the vibration generator unit is configured to navigate at a constant speed along the inspection path, and wherein a time delay between the generations of two consecutive vibration events is constant during the navigation of the vibration generator unit along the inspection path.

9. The method according to claim 8, wherein the vibration generator unit is operated by a human operator.

10. The method according to claim 9, further comprising, subsequent to determining a set of waypoint coordinates of the corresponding waypoint:
establishing a first communication link between an operator device associated with the human operator and the vibration generator unit;
establishing a second communication link between the operator device and an interrogating unit configured to send the plurality of test signals and receive the plurality of return test signals;
receiving, upon the vibration events being generated by the vibration generator unit at a given waypoint, indications of current amplitudes of the return test signal by the operator device from the interrogating unit; and
concurrently displaying the indications of the current amplitude and a current position of the vibration generator unit on a display screen of the operator device.

11. The method according to claim 1, further comprising, prior to performing the plurality of measurements, locating the target ground surface within a ground surface area by:
generating at least one initial vibration event on an exploration point of the ground surface area;
concurrently to the generation of the at least one initial vibration event, sending a plurality of test signals sensitive to the initial vibration events in the underground optical fiber, and receiving one or more return test signal therefrom; and
in response to an amplitude of one of the return test signals being above a pre-determined threshold, identifying the target ground surface as a portion of the ground surface area around the exploration point.

12. The method according to claim 1, further comprising:
determining and storing geolocation data about the relative surface position in a database; and
determining a distance, along the underground optical fiber, between the interrogating unit and the relative surface position based on the geolocation data.

13. A system for locating of an underground optical fiber extending under a target ground surface, the system comprising:
an interrogating unit optically connected to the underground optical fiber and configured to send test signals sensitive to the vibration event in the underground optical fiber and receive return test signals therefrom, the target ground surface being subjected to vibration events generated at waypoints of an inspection path;
a controller communicably connected to the interrogating unit, the controller being configured to:
determine an amplitude of each of said return test signals;
determine a relative surface position corresponding to a position on the target ground surface extending directly above a segment of the underground optical fiber crossed by the inspection path, said relative surface position being associated with a maximum in the amplitudes of the return test signals; and
determine a depth of the underground optical fiber by:
obtaining a vibration fitting curve by fitting the amplitudes of the return signals for each of the waypoints with respect to a distance scale based on sets of waypoint coordinates of the corresponding waypoints; and
calculating the depth of the underground optical fiber from said vibration fitting curve.

14. The system according to claim 13, wherein the interrogating unit is a Distributed Vibration Sensing (DVS) interrogating unit using Optical Time domain Reflectometry (OTDR).

15. The system according to claim 13, wherein the controller is configured to calculate the depth of the underground optical fiber by calculating a distance along the distance scale between a maximum point and a half-maximum point of the vibration fitting curve.

16. The system according to claim 15, wherein the depth of the underground optical fiber corresponds to half a width at half-maximum of the vibration fitting curve.

17. The system according to claim 13, wherein the controller is configured to determine the relative surface position based on a set of waypoint coordinates of a waypoint for which the amplitude of the corresponding return test signal is maximal.

18. The system according to claim 13, wherein the controller is configured to determine the relative surface position based on an abscissa of a maximum of the vibration fitting curve.

19. A method for locating an underground optical fiber extending under a target ground surface, the method comprising:
determining respective relative surface positions of a plurality of segments of the underground optical fiber, the relative surface position of a given segment of the underground optical fiber corresponding to a position on the target ground surface extending directly above the given segment, said determination being performed by, for each segment:
performing a plurality of measurements at a plurality of waypoints of an inspection path over the target ground surface, each measurement comprising:
determining a set of waypoint coordinates of the corresponding waypoint;
generating a vibration event at the corresponding waypoint;
concurrently to the generation of the vibration event, sending a test signal sensitive to the vibration event in the underground optical fiber, and receiving a return test signal therefrom; and
determining an amplitude of the return test signal;
identifying the relative surface position of the segment as a maximum of the amplitudes of the return test signals; and
determining a surface position of a portion of the underground optical fiber extending between at least two consecutive segments of the underground optical fiber thereof based on the relative surface positions thereof.

20. The method according to claim 19, further comprising:
determining respective depths of the at least two consecutive segments by, for each segment:
obtaining a vibration fitting curve by fitting the amplitudes of the return signals for each of the waypoints with respect to a distance scale based on the sets of waypoint coordinates of the corresponding waypoints; and
calculating the depth of the segment from said segment vibration fitting curve; and
determining a position of the portion of the underground optical fiber extending between the at least two consecutive segments based on the relative surface positions and the depths thereof.
